(19) United States
(12) Patent Application Publication
(10) Pub. No.: US 2007/0058675 A1
(43) Pub. Date: Mar. 15, 2007

(54) Channel interface for conveying digital data having a lower data rate

(76) Inventor: Jon David Hendrix, Wimberley, TX (US)

Correspondence Address: GARLICK HARRISON & MARKISON, P.O. BOX 160727, AUSTIN, TX, 78716-0727, US

(21) Appl. No.: 11/222,535

(22) Filed: Sep. 9, 2005

(51) Int. Cl. H04J 3/22

(52) U.S. Cl. 370/468; 370/252

(57) ABSTRACT

Digital data is conveyed over a channel having a frame rate greater than the data rate of the digital data. The digital data is produced at the data rate. From frame to frame, determining whether a digital data sample is available. When the sample of the digital data is available, transmitting, in a current allocated transmission slot of a frame, the sample of the digital data. When the sample of the digital data is not available, transmitting, in the current allocated transmission slot, a predetermined value.

This invention relates generally to portable handheld digital audio systems and more particularly to conveying digital data for components therein.

### DESCRIPTION OF RELATED ART

As is known, handheld digital audio systems are becoming very popular. Such systems include digital audio players/recorders that record and subsequently playback MPEG-3 Layer 3 (“MP3”) files, Windows Media Application (“WMA”) files, etc. Such digital audio players/recorders may also be used as digital dictaphones and file transfer devices. Further feature expansion of digital audio players/recorders includes providing a frequency modulation (“FM”) radio receiver such that the device offers FM radio reception.

Feature set expansion of digital audio players/recorders, however, has been done in a less than optimal manner. For instance, with the inclusion of an FM receiver in a digital audio player/recorder, the FM receiver is a separate integrated circuit from the digital audio player/recorder chip set, or integrated circuit (“IC”). As such, the FM receiver IC has functions that are completely independent of the digital audio player/recorder IC, although both ICs include some common functionality.

The FM receiver IC functions to receive and process radio signals, which may be a digital radio composite signal carrying stereo audio data and informational data that have different data rates. Regardless of the different data rates, a data channel needs to convey the processed radio signal data from the FM receiver IC to the digital audio player/recorder IC for further audio signal processing. Doing so typically requires eliminating the data rate differences through a sample rate conversion process before conveying the data over the data channel. Such additional processing, however, contributes to the processor and power overhead on the limited processor and power resources of the FM receiver IC, and generally to the handheld digital audio system.

Accordingly, a need exists for a channel interface with the capability to convey digital data having different sample rates while minimizing additional processing overhead.

### BRIEF DESCRIPTION OF THE DRAWINGS

FIG. 1 is a schematic block diagram of a handheld audio system in accordance with the present invention;

FIG. 2 is a schematic block diagram of another embodiment of a handheld audio system in accordance with the present invention;

FIG. 3 is a frequency diagram of a digital radio composite signal format;

FIG. 4 is a schematic block diagram of yet another embodiment of a handheld audio system in accordance with the present invention;

FIG. 5 is a schematic block diagram of a digital radio interface in accordance with the present invention;

FIG. 6 is a timing diagram illustrating the interconnectivity of a radio signal decoder integrated circuit and digital audio processing integrated circuit in accordance with the present invention;

FIG. 7 is another timing diagram illustrating the interconnectivity of a radio signal decoder integrated circuit and digital audio processing integrated circuit in accordance with the present invention;

FIG. 8 is a flow diagram illustrating a method for conveying digital data in accordance with the present invention;

FIG. 9 is a flow diagram illustrating a method for determining the availability of digital data of FIG. 8; and

FIG. 10 is another flow diagram illustrating a method for determining the availability of digital data of FIG. 8.

### DETAILED DESCRIPTION

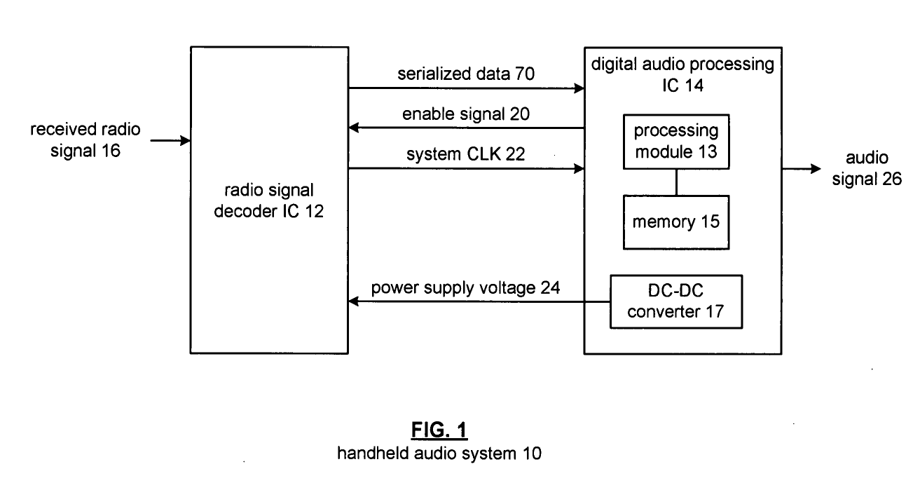

FIG. 1 is a schematic block diagram of a handheld audio system 10 that includes a radio signal decoder integrated circuit (“IC”) 12 and a digital audio processing IC 14. The digital audio processing IC 14 includes a processing module 13, memory 15, and a DC-DC converter 17. The processing module 13 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 15 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 13 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. Further note that, the memory 15 stores, and the processing module 13 executes, operational instructions corresponding to at least some of the steps and/or functions illustrated in FIGS. 1 through 10.

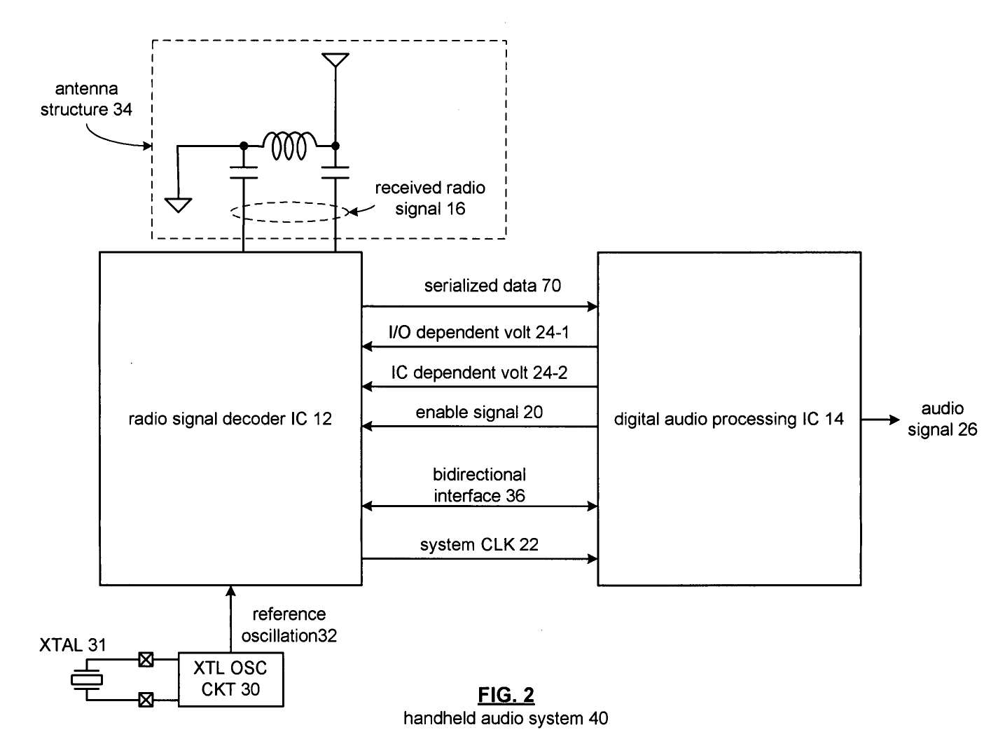

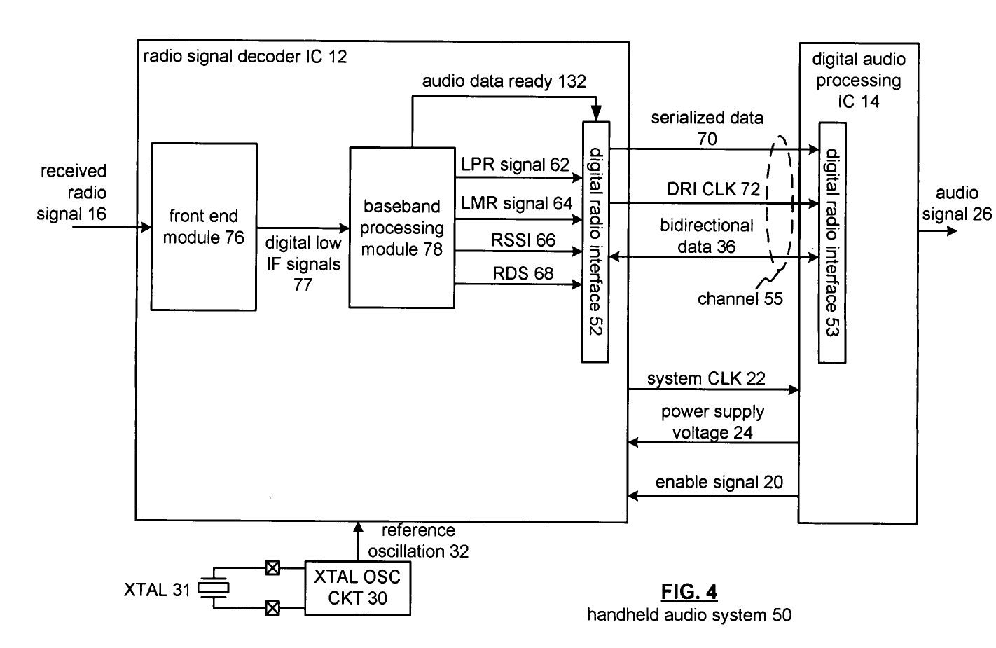

In operation, when a battery, or other external power source, is initially applied to the radio signal decoder IC 12 (described in greater detail with reference to FIGS. 2 and 4) and the digital audio processing IC 14, the DC-DC converter 17 generates a power supply voltage 24 based on an internal oscillation. When the power supply voltage 24 reaches a desired value (for example, near a regulated value), the processing module 13 provides an enable signal 20 to the radio signal decoder IC 12. In response to the enable signal 20, the radio signal decoder IC 12 generates the system clock (“CLK”) 22, with the remaining functionality of the radio signal decoder IC 12 being inactive awaiting a second enable signal or being activated once the system clock 22 is functioning. The radio signal decoder IC 12 provides the system clock 22 to the audio processing integrated circuit 14. Upon receiving the system clock 22, the DC-DC converter 17 switches from the internal oscillation to the system clock 22 to produce the power supply voltage 24 from a battery voltage or an external power source.

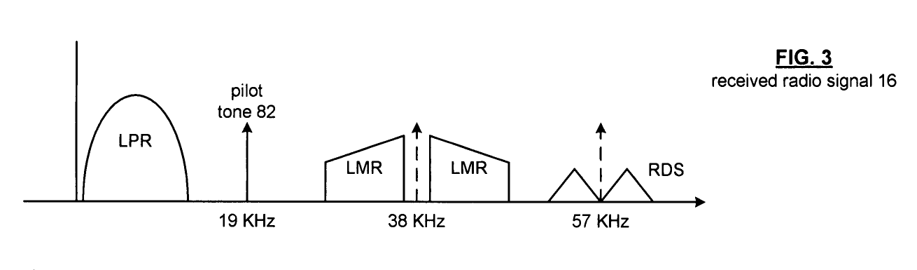

With the system clock 22 functioning, the radio signal decoder IC 12 converts a received radio signal 16 into serialized data 70, which may be analog or digital signals provided at a sample rate suitable for audio processing by the digital audio processing IC 14. In one embodiment, the serialized data 70 include a left-plus-right (“LPR”) signal and a left-minus-right (“LMR”) signal of a digital radio composite signal, the details of which will be discussed with reference to FIG. 3.

The digital audio processing IC 14, which may be a digital audio player/recorder IC such as the STMP35XX and/or the STMP36XX digital audio processing system integrated circuits available from SigmaTel Incorporated of Austin, Texas, receives the serialized data 70 and produces therefrom audio signals 26. The digital audio processing IC 14 may provide the audio signals 26 to a headphone set and/or other type of speaker output. As an alternative to producing the audio signals 26 from the serialized data 70, the digital audio processing integrated circuit 14 may process stored MP3 MPEG-3 Layer 3 (“MP3”) files, stored Windows Media Application (“WMA”) files, and/or other stored digital audio files to produce the audio signals 26.

FIG. 2 is a schematic block diagram of another handheld audio system 40 that includes the radio signal decoder IC 12 and the digital audio processing IC 14. In this embodiment, the radio signal decoder IC 12 is operably coupled to a crystal (“XTAL”) oscillator circuit 30 and an antenna structure 34. The XTAL oscillator circuit 30 is operably coupled to an external XTAL 31 and produces therefrom a reference oscillation 32. The radio signal decoder IC 12, which may include one or more phase locked loops, converts the reference oscillation 32 into an oscillation from which the system clock (“CLK”) 22 is derived. For example, the system clock 22 may be the output oscillation of a phase locked loop, or an oscillation that is a multiple or fraction of the output oscillation of the phase locked loop.

The XTAL oscillator circuit 30 is operably coupled, via integrated circuit pins, to an external XTAL 31 to produce a reference oscillation 32. The reference oscillation 32 is based on the properties of the external XTAL 31 and, as such, may range from a few mega-Hertz to hundreds of mega-Hertz. In an embodiment, the reference oscillation 32 produces the system CLK 22. As one of ordinary skill in the art will appreciate, the system CLK 22 may be identical to the reference oscillation 32, may have a rate that is a multiple of a reference oscillation 32, may have a rate that is a fraction of the reference oscillation 32, may have a phase shift with respect to the reference oscillation 32, or a combination thereof.

The antenna structure 34 includes an antenna, a plurality of capacitors, and an inductor coupled as shown. The antenna structure 34 provides the received radio signal 16 to the radio signal decoder IC 12. As with the embodiment of FIG. 1, the radio signal decoder IC 12 converts the received radio signal 16 into serialized data 70.

The digital audio processing IC 14, via the DC-DC converter 17, generates an input/output (“I/O”) dependent supply voltage 24-1 and an IC dependent voltage 24-2 that are each supplied to the radio signal decoder IC 12. In one embodiment, the I/O dependent voltage 24-1 is dependent on the supply voltage required for input/output interfacing of the radio signal decoder IC and/or the digital audio processing IC 14 (for example, 3.3 volts). The IC dependent voltage 24-2 is dependent on the IC process technology used to produce integrated circuits 12 and 14. In an embodiment, the integrated circuit process technology is 0.08 to 0.35 micron CMOS technology where the IC dependent voltage 24-2 is 1.8 volts or less.

The interface between the integrated circuits 12 and 14 further includes a bi-directional interface 36. Such an interface may be a serial interface for the integrated circuits 12 and 14 to exchange control data and/or other type of data, including the enable signal 20. In one embodiment, the bi-directional interface 36 may be one or more serial communication paths that are in accordance with, but not limited to, the Inter-IC (“I²C”) serial transmission protocol. As one of ordinary skill in the art will appreciate, other, serial transmission protocols may be used for the bi-directional interface 36, which may also include one or more serial transmission paths.

FIG. 3 is a frequency diagram of the digital radio composite signal used to carry stereophonic audio under a pilot-tone multiplex system. A pilot-tone multiplex system multiplexes the left and right audio signal channels in a manner compatible with mono sound, using a sum-and-difference technique to produce a “mono-compatible” composite signal. The signal includes a pilot tone 82 at 19 kHz and another tone at 38 kHz. The signal 16 also includes digital left-channel and digital right-channel data in the form of a low frequency “sum” or left-plus-right (“LPR”) signal component, and a higher frequency “difference” or left-minus-right (“LMR”) signal component. Also shown is a radio data system (“RDS”) signal component. The LMR signal component is modulated on the 38 kHz suppressed subcarrier to produce a double sideband suppressed carrier signal (“DSBCS”). The RDS signal component contains digital information including time and radio station identification, and uses a sub-carrier tone at 57 kHz.

FIG. 4 is a schematic block diagram of yet another embodiment of a handheld audio system 50 that includes the radio signal decoder IC 12 and the digital audio processing IC 14. In this embodiment, the radio signal decoder IC 12 includes a front-end module 76, a baseband processing module 78, and a digital radio interface 52. The digital audio processing IC 14 includes a digital radio interface 53. The digital radio interface 52 and the digital radio interface 53 are coupled via a channel 55. The channel 55 may be a synchronous or asynchronous channel. The front-end module 76 contains circuitry to process and convert the received radio signal 16 to digital data, shown as digital low intermediate frequency (“IF”) signals 77. The baseband processing module 78 is operably coupled to convert the digital low IF signals 77 into digital baseband signals and to produce therefrom the LPR signal 62 and LMR signal 64 that contain the audio data provided by the received radio signal 16. For a more detailed discussion of the front-end circuitry and/or the baseband processing refer to co-pending patent application entitled HANDHELD AUDIO SYSTEM, having a filing date of May 11, 2005, and a Ser. No. 11/126,554, which is hereby incorporated herein by reference.

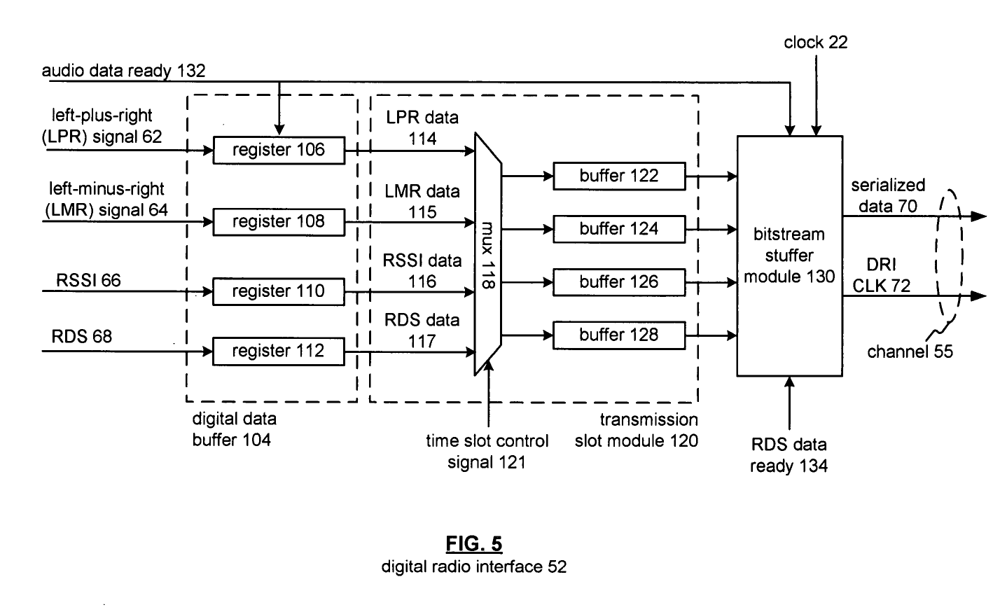

The digital radio interface 52 is operably coupled to the digital radio interface 53 to provide the LPR signal 62, the LMR signal 64, and the RDS data 68 to the digital audio processing integrated circuit 14. The details of the digital radio interface 52 will be discussed with reference to FIG. 5. Within the radio signal decoder IC 12, the digital radio interface 52 converts the parallel LPR signal 62, LMR signal 64, and RDS data 68 into a serialized data signal 70. The digital radio interface 53 converts the serialized data 70 back into parallel signals for further audio signal processing by the digital audio processing IC 14. Note that the serial-to-parallel and parallel-to-serial functionality of the digital radio interfaces 52 and 53 may be programmable based on the sample rate of the radio signal decoder IC 12, a desired data rate, or other parameters of the ICs 12 and 14 (for example, 44.1 KHz, 48 KHz, multiples thereof, and/or fractions thereof).

The digital radio interface 52 may convey more than left-and-right channel signals, shown as LPR signal 62 and the LMR signal 64. For instance, the digital radio interface 52 may convey Receive Signal Strength Indications (“RSSI”) 66, data clock rates, control information, functionality enable/disable signals, functionality regulation and/or control signals, and Radio Data Service (“RDS”) signals 68 between the ICs 12 and 14.

FIG. 5 is a schematic block diagram of the digital radio interface 52 that includes a digital data buffer 104, a transmission slot module 120, and a bitstream stuffer module 130. The digital data buffer 104 includes registers 106, 108, 110, and 112. The transmission slot module 120 includes a multiplexer 118 and buffers 122, 124, 126 and 128.

The registers of the digital data buffer 104 are 16-bit words and operate to temporarily hold samples of data until routed to the allocated slots of the transmission slot module 120 via the multiplexer 118. The register 106 buffers a sample of the LPR signal 62 to provide the LPR data 114. The register 108 buffers the LMR signal 64 to provide the LMR data 115. The register 110 buffers the RSSI 66 to provide the RSSI data 116. The register 112 buffers the RDS data 68 to provide the RDS data 117.

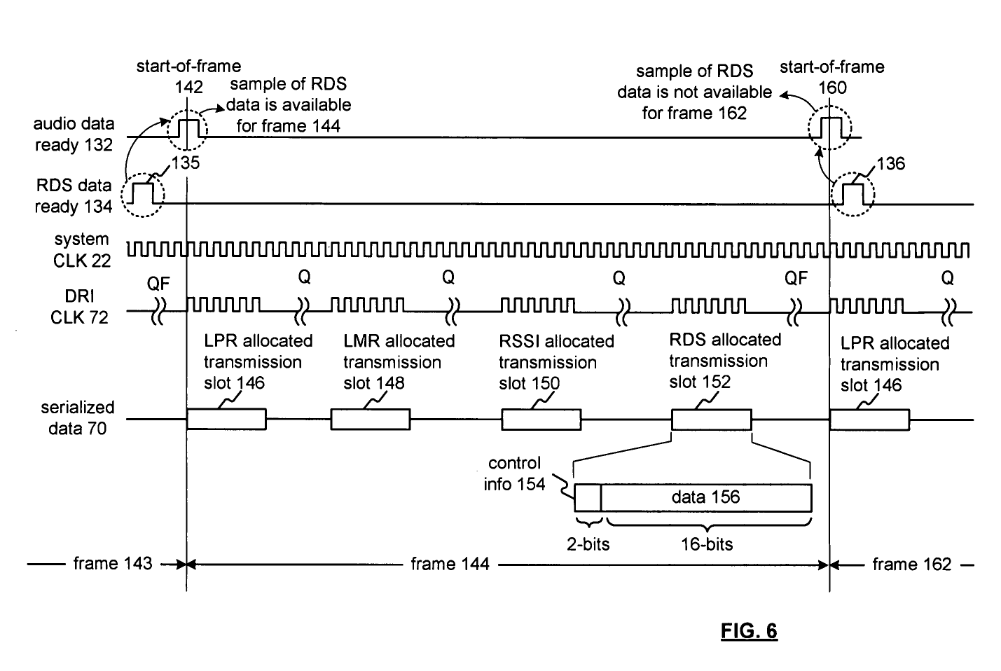

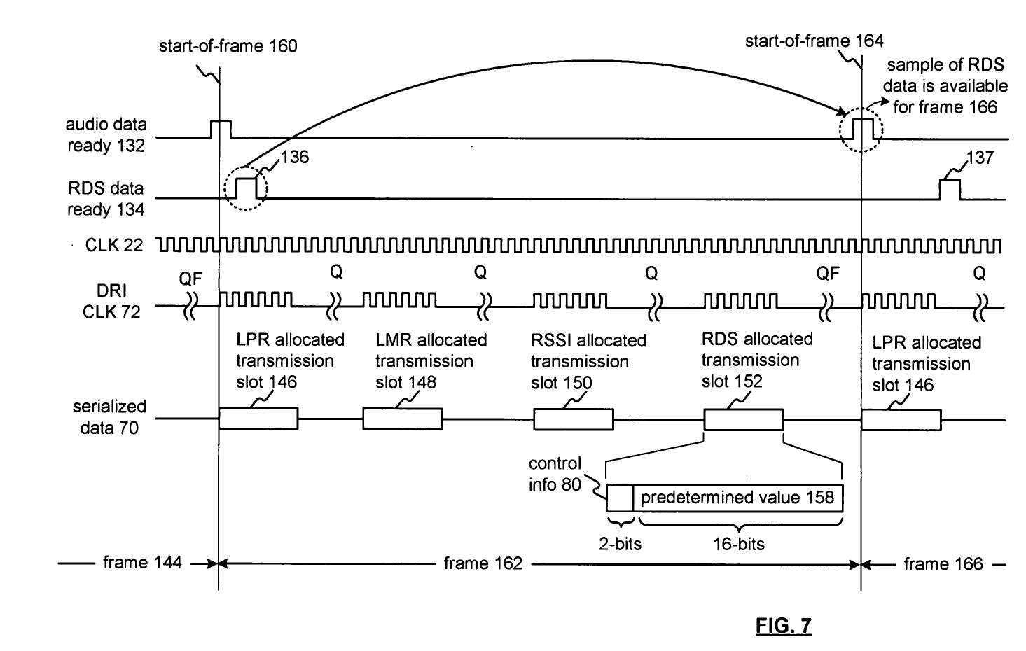

The multiplexer 118, based on the time slot control signal 121, separates and populates the buffers of the transmission slot module 120. As with the registers of the digital data buffer 104, the buffers are 16-bit words, and contain data to be assembled by the bitstream stuffer module 130 to produce the serialized data 70. The details of the serialized data 70 will be discussed with reference to FIGS. 6 and 7. The multiplexer 118 populates the buffer 122 with the LPR data 114, the buffer 124 with the LMR data 115, the buffer 126 with the RSSI data 116, and the buffer 128 with the RDS data 117. The bitstream stuffer module 130 receives the buffer contents from the transmission slot module 120 and assembles a serialized data 70 conveyed to the DRI 53 of the digital audio processing IC 14 (see FIG. 3). Note that multiplexer 118 and the time slot control signal 121 may be programmable to adjust the population order of the buffers. Also, that the lengths of the registers for the digital data buffer 104 and the buffers for the transmission slot module 120 may be increased or decreased to accommodate varying data sizes or system architecture of the radio signal decoder IC 12, such as a 4-bit word, an 8-bit word, a 32-bit word, etc.

In operation, the DRI 52 provides parallel-to-serial conversion of the LPR signal 62, the LMR signal 64, the RSSI 66, and the RDS 68 as the serialized data 70 based on the inputs of audio data ready 132 and RDS data ready 134. The audio data ready 132 corresponds to the sample rate of the LPR signal 62 and the LMR signal 64, which for example are at 44.1 kilo-Samples-per-second (“kS/s”). The RDS data ready 134 corresponds to the slower sample rate of the RDS 68, which for example is at 38 kS/s. In other words, the sample rate of the audio information is greater than the data rate of the RDS information.

The higher sample rate of the LPR signal 62 and the LMR signal 64 drive the frame rate of the serialized data 70. To accommodate the lower sample rate digital data (for example, the RDS data) on a frame-by-frame basis, the availability of RDS data is determined. When a sample of the RDS 68, in the form of RDS data 117, is available, the RDS data ready 134 pulses. The bitstream stuffer module 130 transmits the RDS data 117 in the current allocated slot at the frame rate of the serialized data 70. When the sample of the RDS 68 is not available, the RDS data ready signal 134 will not be set. In this instance, the bitstream stuffer module 130 transmits a predetermined value in the current allocated slot. The predetermined value can be a known invalid word (for example, 0x7FFF) that the digital audio processing IC 14 will discard instead of process. The details of the availability and unavailability of the RDS 68 will be discussed with reference to FIGS. 6 through 10.

FIG. 6 illustrates a timing diagram of data transmission via the channel between 55 the digital radio interface 52 of IC 12 and the digital radio interface 53 of IC 14 when the RDS data is available for frame 144. As shown, an audio data ready signal 132 is periodically activated at a rate greater than that of the RDS data ready signal 134. For the example provided earlier with respect to FIG. 5, audio data ready signal 132 is at 44.1 kHz, and RDS data ready 134 is at 38.0 kHz. As noted earlier, the system clock 22 corresponds to the data clock that is derived from the reference oscillation 32 (see FIG. 4). The rate for the system clock 22 may range from a few megahertz to hundreds-of-megahertz and greater.

From the audio data ready signal 132 and the system clock 22, the digital radio interface 52 generates a digital radio interface clock (“DRI CLK”) 72. The DRI CLK 72 includes a clocking portion, which has a frequency corresponding to the system clock 22, and a plurality of quiet periods Q. The quiet periods Q correspond to a rate of the audio data ready 132 and the serialized data 70 are at a logic “low,” and may be provided with selectable or programmable durations with respect to the system clock 22. The final quiet period QF is the quiet time before the first rising edge of the system clock 22 after the audio data ready 132 is activated or pulses.

The bitstream stuffer module 130 generates the serialized data 70, which is transmitted between the integrated circuits 12 and 14 in accordance with the DRI CLK 72. During the quiet periods Q, no data is transmitted. As such, serialized data 70 is only transmitted when the DRI CLK 72 is active following the occurrence of a start-of-frame, such as start-of-frame 142, designated at the first rising edge of the system clock 22 occurring after the audio data ready 132 pulses. The serialized data 70 is transmitted at a frame rate (that is, “x” number of frames per second). In one embodiment, a frame includes one or more words, with each word including one or more allocated transmission slots (for example, one-to-five allocated transmission slots). Each word includes 18 bits—two are used for control information 154 and the remaining sixteen bits are used for data 156. The serialized data 70 may be formatted in accordance with one or more serial data transmission protocols, which also may include one or more serial transmission paths.

Referring to frame 144 as an example, each frame of the serialized data 70 includes an LPR allocated transmission slot 146 to transmit LPR data, a LMR allocated transmission slot 148 to transmit LMR data, a RSSI allocated transmission slot 150 to transmit RSSI data, and a RDS allocated transmission slot 152 to transmit RDS data, that are transmitted between the start-of-frame 142 and the start-of-frame 160.

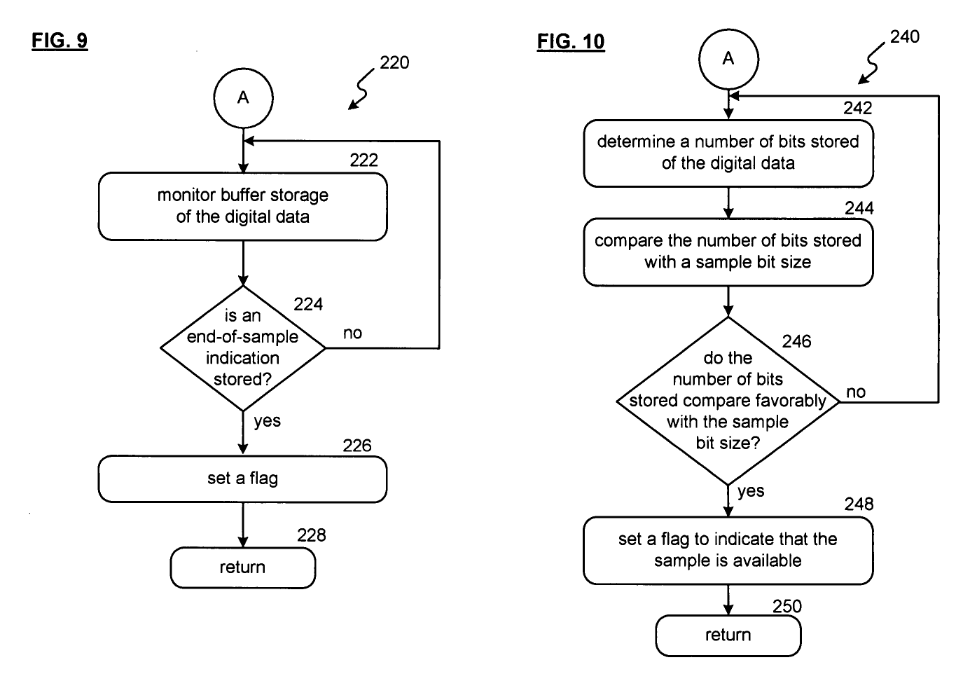

The RDS data ready 134 produces a pulse 135 when a sample of the RDS data 117 is available for transmission in the serialized data 70 with the audio data associated with the LPR data 114 and LMR data 115. Such a pulse may be provided by setting a flag upon an indication of availability, by a periodic pulse, such as one corresponding to the sample rate of the data (that is, 38 kS/s), or by a combination thereof. The details of the use of flags will be discussed with reference to FIGS. 9 and 10. When the RDS data ready 134 produces a pulse 135 within the cycle of frame 143 as indicated by the dashed circles around pulse 135 and pulse 142, the sample of digital data is available. The bitstream stuffer module 130 places the available sample of the digital data in the data 156 portion of the current allocated transmission slot, which is transmitted in the RDS allocated transmission slot 152 within the frame 144.

As noted earlier, because the frame rate of the serialized data 70 is greater than the sample rate of the RDS data 117, the RDS data 117 is not refreshed, or available, as frequently as the audio data having a sample rate that corresponds to channel frame rate. As shown, the next pulse 136 of the RDS data ready 134 occurs outside the cycle of the frame 144 (that is, from start-of-frame 142 to start-of-frame 160). Accordingly, the RDS data 117 is unavailable for the next frame 162, as indicated by the dashed circles about the pulse 136 and the pulse 160. Details of the frame 162 are discussed with reference to FIG. 7.

FIG. 7 illustrates a timing diagram of data transmission via the data channel between the digital radio interface 52 of IC 12 and the digital radio interface 53 of IC 14 when RDS data is not available for the RDS allocated transmission slot 152 of frame 162. When the RDS data is not available, the bitstream stuffer module 130 places a predetermined value 158 in the current allocated transmission slot, which is transmitted in the RDS allocated transmission slot 152 of frame 162. The predetermined value 158, which may be a known invalid word (for example, 0x7FFF), is subsequently ignored or discarded when processed by the digital audio processing IC 14.

The availability of a sample of the RDS 68 is subsequently determined to be available by the pulse 136 occurring within the cycle of frame 162 (that is, from start-of-frame 160 to start-of-frame 164), as indicated by the dashed circles about pulse 160 and pulse 164. Accordingly, the RDS data 117 is available and placed by the bitstream stuffer module 130 in the current RDS allocated slot for transmission with the frame 166. The process is repeated with respect to the availability indicated by RDS data ready 134 and audio data ready 132.

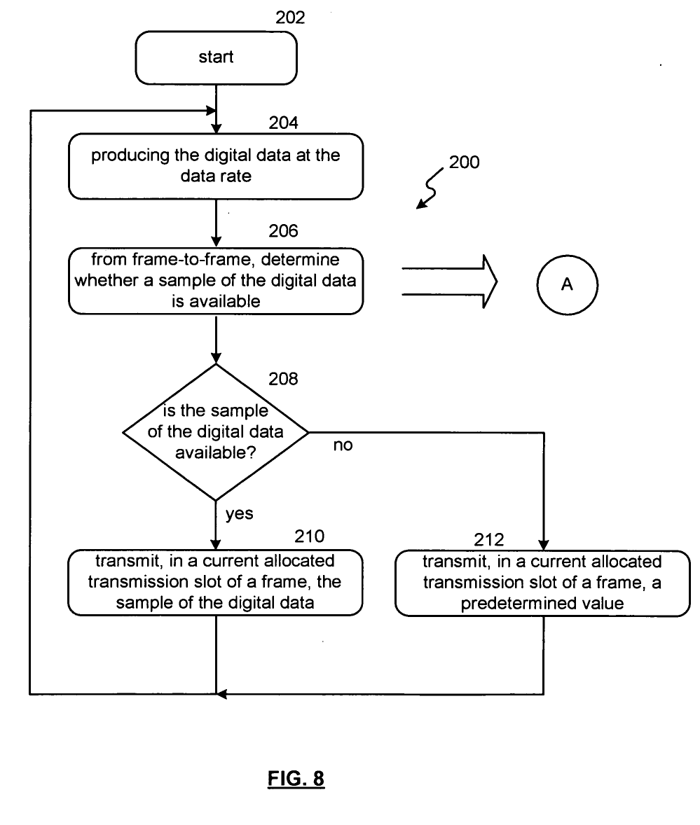

FIG. 8 is a flow diagram 200 illustrating a method for conveying digital data, at a data rate, over a channel having a frame rate greater than the data rate. The method begins at step 202. At step 204, the digital data, such as RDS data, is produced at the data rate, such as 38 kS/s. From frame-to-frame, at step 206, a determination is made as to whether a sample of the digital data is available. The determination of whether a sample of the digital data is available may be done as discussed in detail with respect to the flow diagram 220 of FIG. 9, and with respect to the flow diagram 240 of FIG. 10. At step 208, if a sample of the digital data is not available, then, in a current allocated transmission slot of a frame, a predetermined value is transmitted at step 212. Otherwise, a sample of the digital data is available, is placed in a current allocated transmission slot, and is transmitted at step 210.

FIG. 9 is a flow diagram 220 illustrating a method of determining whether a sample of the digital data is available. At step 222, the buffer storage of the digital data is monitored. If an end-of-sample indication has been stored at step 224, then at step 226, a flag is set. Otherwise, the buffer storage is continued to be monitored at step 222. After the flag is set at step 226, the method returns to the main path of the flow diagram 200 of FIG. 8.

FIG. 10 is a flow diagram 240 illustrating another method of determining whether a sample of the digital data is available. At step 242, a number of bits stored of the digital data is determined, and at step 244, is compared with the number of bits stored with a sample bit size. If, at step 246, the number of bits stored compare favorably with the sample bits size, then a flag is set to indicate that the sample is available at step 248. Otherwise, the method continues at step 242 to determine a number of bits stored of the digital data. After the flag is set at step 248, the method returns to the main path of the flow diagram 200 of FIG. 8.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (that is, where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that a first signal has a greater magnitude than a second signal, a favorable comparison may be achieved when the magnitude of the first signal is greater than that of the second signal or when the magnitude of the second signal is less than that of the first signal.

The preceding discussion has presented a handheld device that incorporates a radio signal decoder integrated circuit having a digital radio interface with the capability to convey digital data having different sample rates with reduced processing and power overhead. As one of average skill in the art will appreciate, other embodiments may be derived from the teaching of the present invention without deviating from the scope of the claims.

What is claimed is:

1. A method for conveying digital data at a data rate over a channel having a frame rate greater than the data rate comprises:
producing the digital data at the data rate;
from frame to frame, determining whether a sample of the digital data is available;
when the sample of the digital data is available, transmitting, in a current allocated transmission slot of a frame, the sample of the digital data; and
when the sample of the digital data is not available, transmitting, in the current allocated transmission slot, a predetermined value.

2. The method of claim 1 wherein the frame comprises one-to-five words, wherein each of the one-to-five words includes 18 bits, wherein 16 of the 18 bits are for data and two of the 18 bits are for control information.

3. The method of claim 1 wherein the digital data comprises a radio data system (RDS) data.

4. The method of claim 1 wherein the channel comprises an asynchronous channel.

5. The method of claim 1 further comprises:
determining that the sample of the digital data is available by:
monitoring buffer storage of the digital data; and
when an end of sample indication is stored, setting a flag.

6. The method of claim 1 further comprises:
determining that the sample of the digital data is available by:
determining a number of bits stored of the digital data;
comparing the number of bits stored with a sample bit size; and
when the number of bits stored compares favorably with the sample bit size, setting a flag to indicate that the sample is available.

7. The method of claim 1, wherein the predetermined value comprises a known invalid word.

8. A handheld audio system comprises:
a radio signal decoder integrated circuit operably coupled to produce radio data system (RDS) data, digital left-channel data, and digital right-channel data; and
a digital audio processing integrated circuit operably coupled to the radio signal decoder integrated circuit via a channel, wherein the digital audio processing integrated circuit produces audio signals for audio playback from at least one of the digital left- and right-channel data and a stored digital audio file,
wherein the radio signal decoder integrated circuit includes:
a processing module, and
memory operably coupled to the processing module, wherein the memory stores operational instructions that cause the processing module to:
from frame to frame, determine whether a sample of the RDS data is available;
when the sample of the RDS data is available, transmitting, in a current allocated transmission slot of a frame, the sample of the RDS data; and
when the sample of the RDS data is not available, transmitting, in the current allocated transmission slot of the frame, a predetermined value.

9. The handheld audio system of claim 8 wherein the frame comprises one-to-five words, wherein each of the one-to-five words includes 18 bits, wherein 16 of the 18 bits are for data and two of the 18 bits are for control information.

10. The handheld audio system of claim 8 wherein the radio signal decoder integrated circuit comprises:
a digital radio interface that provides parallel-to-serial conversions for at least one of:
a left-channel plus right-channel signal of the digital left- and right-channel data;
a left-channel minus right-channel signal of the digital left- and right-channel data;
a received signal strength indication; and
the RDS data.

11. The handheld audio system of claim 8 wherein the channel comprises an asynchronous serial channel, wherein a frame rate of the channel corresponds to a frame rate of the digital left- and right-channel data.

12. The handheld audio system of claim 8 wherein the digital audio processing integrated circuit further functions to:
demodulate and decode the RDS data to produce RDS application information.

13. The handheld audio system of claim 12 wherein the memory further comprises operational instructions that cause the processing module to determine that the sample of the RDS data is available by:
monitoring a buffer storage of the RDS data; and
when an end of sample indication is stored, setting a flag.

14. The handheld audio system of claim 12 wherein the memory further comprises operational instructions that cause the processing module to determine that the sample of the RDS data is available by:
determining a number of bits stored of the RDS data;
comparing the number of bits stored with a sample bit size; and
when the number of bits stored compares favorably with the sample bit size, setting a flag to indicate that the sample is available.

15. The handheld audio system of claim 8, wherein the predetermined value comprises a known invalid word.

16. A digital radio interface comprises:
a digital data buffer module operably coupled to buffer left-plus-right data, left-minus-right data, and radio data system (RDS) data;
a transmission slot module operably coupled to populate, on a frame by frame basis, time slots of a frame of a plurality of frames with the left-plus-right data, left-minus-right data, and RDS data; and
a bitstream stuffer module operably coupled to produce a serial stream of the plurality of frames, wherein each of the plurality of frames includes an allocated transmission slot for the RDS data, wherein the bitstream stuffer module is further operably coupled to:
when the allocated transmission slot for a current frame of the plurality of frames is to be transmitted, determine whether a RDS data ready signal is set;
when the RDS data ready signal is set, transmit the RDS data in the allocated transmission slot; and
when the RDS data ready signal is not set, transmit known invalid data in the allocated transmission slot.

17. The digital radio interface of claim 16 wherein the frame comprises one-to-five words, wherein each of the one-to-five words includes 18 bits, wherein 16 of the 18 bits are for data and two of the 18 bits are for control information.

18. The digital radio interface of claim 16 wherein the digital data buffer module comprises:
a plurality of buffers operably coupled to buffer the left-plus-right data, left-minus-right data, and RDS data.

19. The digital radio interface of claim 16 wherein the transmission slot module comprises:
a plurality of buffers operably coupled to provide the time slots of the frame; and
a multiplexer operably coupled to separate the left-plus-right data, left-minus-right data, and RDS data and to populate therefrom each of the plurality of buffers based on a time slot control signal.

20. The digital radio interface of claim 19 wherein the multiplexer comprises a programmable multiplexer based on a frame length of the frame.

21. A method of transmitting data having a lower data rate than a transmission rate of a channel comprises:
determining a number of bits stored of the data;
comparing the number of bits stored with a predetermined quantity;
when the number of bits stored compares favorably with the predetermined quantity, transmitting the data in an allocated transmission slot of a frame; and when the number of bits stored does not compare favorably with the predetermined quantity, transmitting invalid data in the allocated transmission slot of the frame.

22. The method of claim 21 wherein the predetermined quantity comprises a sample bit size.

23. The method of claim 21 wherein the predetermined quantity comprises a 2-bit word.
